(19) United States
(12) Patent Application Publication
(10) Pub. No.: US 2026/0370410 A1
(43) Pub. Date: Nov. 19, 2026

(54) CONFIGURATION OF MULTIPLE DEMODULATION REFERENCE SIGNAL PATTERNS

(71) Applicant: Nokia Technologies Oy, Espoo (FI)

(72) Inventors: Youngsoo YUK, Seoul (KR); Juha Pekka KARJALAINEN, Oulu (FI); Pasi Eino Tapio KINNUNEN, Oulu (FI); Petri LUOTO, Oulu (FI)

(21) Appl. No.: 19/103,140

(22) PCT Filed: Aug. 12, 2022
(86) PCT No.: PCT/EP2022/072649

§ 371 Date: Feb. 11, 2025

(51) Int. Cl. H04L 5/00

(52) U.S. Cl. CPC H04L 5/0051

(57) ABSTRACT

Example embodiments of the present disclosure relate to configurations for multiple demodulation reference signal patterns. A terminal device receives a configuration associated with a plurality of demodulation reference signal (DMRS) patterns from a network device. The terminal device determines a DMRS pattern from the plurality of DMRS patterns based at last partly on the configuration. In this way, DMRS patterns can be indicated and switched dynamically, thereby improving communication performances.

### FIELD

Various example embodiments of the present disclosure generally relate to the field of telecommunication and in particular, to methods, devices, apparatuses and computer readable storage medium for configuration of multiple demodulation reference signal patterns.

### BACKGROUND

With development of communication industry, different technologies have been proposed to improve communication performance. For example, multi-input-multi-output (MIMO) has been proposed. Enhancements on communication operations are needed for the MIMO evolution.

### SUMMARY

In a first aspect of the present disclosure, there is provided an apparatus. The apparatus comprises at least one processor; and at least one memory storing instructions that, when executed by the at least one processor, cause the apparatus at least to: receiving, from a network device, a configuration associated with a plurality of demodulation reference signal patterns; and determining, based at least partly on the configuration, a demodulation reference signal pattern to be used from the plurality of demodulation reference signal patterns.

In a second aspect of the present disclosure, there is provided an apparatus. The apparatus comprises at least one processor; and at least one memory storing instructions that, when executed by the at least one processor, cause the apparatus at least to: transmitting, to a terminal device, a configuration associated with a plurality of demodulation reference signal patterns, the configuration being used for determining a demodulation reference signal pattern to be used from the plurality of demodulation reference signal patterns.

In a third aspect of the present disclosure, there is provided a method. The method comprises: receiving, at a terminal device and from a network device, a configuration associated with a plurality of demodulation reference signal patterns; and determining, based at least partly on the configuration, a demodulation reference signal pattern to be used from the plurality of demodulation reference signal patterns.

In a fourth aspect of the present disclosure, there is provided a method. The method comprises: transmitting, at a network device and to a terminal device, a configuration associated with a plurality of demodulation reference signal patterns, the configuration being used for determining a demodulation reference signal pattern to be used from the plurality of demodulation reference signal patterns.

In a fifth aspect of the present disclosure, there is provided an apparatus. The apparatus comprises: means for receiving, from a network device, a configuration associated with a plurality of demodulation reference signal patterns; and means for determining, based at least partly on the configuration, a demodulation reference signal pattern to be used from the plurality of demodulation reference signal patterns.

In a sixth aspect of the present disclosure, there is provided an apparatus. The apparatus comprises: means for transmitting, to a terminal device, a configuration associated with a plurality of demodulation reference signal patterns, the configuration being used for determining a demodulation reference signal pattern to be used from the plurality of demodulation reference signal patterns.

In a seventh aspect of the present disclosure, there is provided a computer readable medium. The computer readable medium comprises instructions which, when executed by an apparatus, cause the apparatus to perform at least the following: receiving, from a network device, a configuration associated with a plurality of demodulation reference signal patterns; and determining, based at least partly on the configuration, a demodulation reference signal pattern to be used from the plurality of demodulation reference signal patterns.

In an eighth aspect of the present disclosure, there is provided a computer readable medium. The computer readable medium comprises instructions which, when executed by an apparatus, cause the apparatus to perform at least the following: transmitting, to a terminal device, a configuration associated with a plurality of demodulation reference signal patterns, the configuration being used for determining a demodulation reference signal pattern to be used from the plurality of demodulation reference signal patterns.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for communication according to some example embodiments of the present disclosure;

FIG. 3 illustrates a signaling chart for communication according to some example embodiments of the present disclosure;

FIG. 4 illustrates a signaling chart for communication according to some example embodiments of the present disclosure;

FIG. 5 illustrates a signaling chart for communication according to some example embodiments of the present disclosure;

FIG. 6 illustrates a signaling chart for communication according to some example embodiments of the present disclosure;

FIG. 7 illustrates a flowchart of a method implemented at a first device according to some example embodiments of the present disclosure;

FIG. 8 illustrates a flowchart of a method implemented at a second device according to some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As mentioned above, enhancements on communication operations are needed. For example, enhancements are on uplink (UL) and downlink (DL) demodulation reference signal (DMRS) operation. According to some solutions, larger number of DMRS ports for downlink and uplink MIMO is proposed. For example, it may be up to 24 orthogonal DMRS ports where for each applicable DMRS type, the maximum number of orthogonal ports is doubled for both single-symbol and double-symbol DMRS.

Distributions of resource elements used for DMRS within one slot or cross slots may be referred to a DMRS pattern. For example, the DMRS pattern may specify a number of resource elements in total per physical resource block (PRB) for carrying DMRSs on a number of antenna ports for transmissions. The DMRS pattern may have a maximum number of DMRS antenna ports that can be supported. In present disclosure, the terms “DMRS pattern” and “DMRS type” may be used interchangeably. In order to support large number of DMRS ports up to 24, new enhanced DMRS pattern needs to be supported. To support more orthogonal DMRS ports, enhanced DMRS pattern may have different resource element (RE) patterns from the RE patterns of the normal DMRS, which only supports up to 8 or 12 DMRS ports. Because of supporting large number of DMRS antenna ports, with sacrificing performance, the UE may not be required to be scheduled with the enhanced DMRS pattern when the number of DMRS antenna ports not more than the support for the normal DM-RS pattern is. This means, the UE may support both normal DM-RS and enhanced DMRS RE patterns in the different slots according to the use case. However, according to some solution, DMRS configurations are radio resource control (RRC) configured and switching between DMRS RE patterns slot by slot is not supported. Therefore, solutions on supporting different DMRS patterns for a terminal device are needed.

### Example Environment

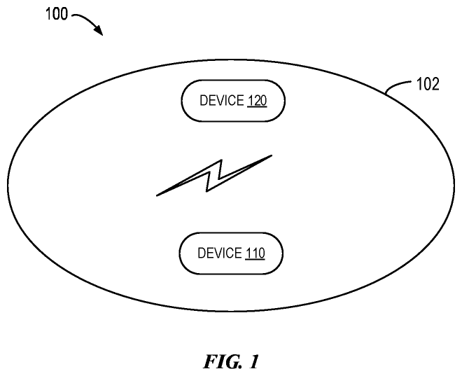

FIG. 1 illustrates an example communication environment 100 in which example embodiments of the present disclosure can be implemented. In the communication environment 100, a plurality of communication devices, including a first device 110 and a second device 120, can communicate with each other.

In the example of FIG. 1, the first device 110 may include a terminal device and the second device 120 may include a network device serving the terminal device. The serving area of the second device 120 may be called a cell 102.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell 102, and one or more additional cells may be deployed in the communication environment 100. It is noted that although illustrated as a network device, the second device 120 may be other device than a network device. Although illustrated as a terminal device, the first device 110 may be other device than a terminal device.

In the following, for the purpose of illustration, some example embodiments are described with the first device 110 operating as a terminal device and the second device 120 operating as a network device. However, in some example embodiments, operations described in connection with a terminal device may be implemented at a network device or other device, and operations described in connection with a network device may be implemented at a terminal device or other device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

According to some example embodiments of the present disclosure, there is provided a solution for configuration of multiple DMRS patterns. In this solution, a first device receives a configuration associated with a plurality of DMRS patterns from a second device. The first device determines a DMRS pattern from the plurality of DMRS patterns based at least partly on the configuration. In this way, DMRS patterns can be indicated and switched dynamically, thereby improving communication performances.

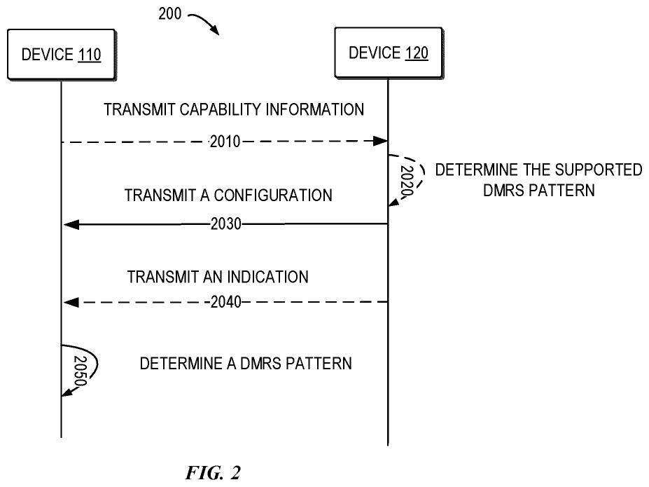

Reference is now made to FIG. 2, which shows a signaling chart 200 for communication according to some example embodiments of the present disclosure. As shown in FIG. 2, the signaling chart 200 involves a first device 110 and a second device 120. For the purpose of discussion, reference is made to FIG. 1 to describe the signaling chart 200. Although one first device 110 and one second device 120 are illustrated in FIG. 2, it would be appreciated that there may be a plurality of first device performing similar operations as described with respect to the first device 110 below and a plurality of second device performing similar operations as described with respect to the second device 120 below.

In some example embodiments, the first device 110 may transmit 2010 capability information to the second device 120. In some example embodiments, the capability information may indicate one or more DMRS patterns that can be supported by the first device 110. For example, the capability information may indicate that the DMRS pattern supported by the first device 110 may specify 12 resource elements in total per PRB for carrying DMRSs with the maximum number of antenna ports being 12. Alternatively, the capability information may indicate that the DMRS pattern supported by the first device 110 may specify 24 resource elements in total per PRB for carrying DMRSs with the maximum number of antenna ports being 24. In some example embodiments, the DMRS pattern may be for DL PDSCH reception. Alternatively, or in addition, the DMRS pattern may be for UL PUSCH transmission.

In some example embodiments, the capability information may indicate that the first device 110 can support 8 DMRS ports and 16 DMRS ports for DMRS type 1 and 12 DMRS ports and 24 DMRS ports for DMRS type 2. DMRS Type 1 may correspond to every other resource element in frequency being occupied by a DMRS symbol. DMRS Type 2 may correspond to two consecutive resource elements occupied by DMRS symbols out of each group of six resource elements. As another example, the capability information may indicate that the first device 110 can support 8 DMRS ports for DMRS type 1 and 12 DMRS ports for DMRS type 2. The second device 120 may determine 2020 one or more DMRS patterns supported by the first device 110 based on the capability information.

The second device 120 transmits 2030 a configuration associated with a plurality of DMRS patterns. In some example embodiments, the configuration may include a time domain resource allocation (TDRA) table which contains a plurality of TDRA entries. In this case, in some example embodiments, a TDRA entry may comprise an indication of DMRS pattern. In other words, the TDRA entry may indicate what DMRS pattern is applied. In some example embodiments, the TDRA table may be configured for DL. Alternatively, or in addition, the TDRA table may be configured for UL.

Alternatively, the configuration may indicate a first mapping between the plurality of DMRS patterns and a set of search spaces. For example, the first mapping may indicate that a first search space is associated with a first DMRS pattern and a second search space is associated with a second DMRS pattern. In other words, the first mapping may indicate a certain search space is associated with a certain DMRS pattern. The term “search space” used herein can refer to an area in downlink resource grid where physical downlink control channel (PDCCH) may be carried. In some example embodiments, the set of search spaces may comprise a common search space (CSS). For example, the set of search spaces may comprise one or more of: a Type-0 PDCCH CSS, a Type0A-PDCCH CSS, a Type1-PDCCH CSS, a Type2-PDCCH CSS, or a Type3-PDCCH CSS. Alternatively, the set of search spaces may include a UE specific search space. In some example embodiments, the first mapping may be for a DL reception. Alternatively, or in addition, the first mapping may be for an UL transmission. In some other example embodiments, the first mapping may be for DL and UL.

In some other embodiments, the configuration may indicate a second mapping between the plurality of DMRS patterns and a set of DCI formats. For example, the second mapping may indicate that a first search space is associated with a first DMRS pattern and a second search space is associated with a second DMRS pattern. In other words, the second mapping may indicate a certain DCI format is associated with a certain DMRS. The term “DCI format” used herein can refer to a predefined format in which the downlink control information is packed/formed and transmitted in PDCCH. For example, the set of DCI formats may include one or more of: DCI_format 0, DCI_format 1, or DCI_format 2.

The second device 120 may transmit 2040 an indication indicating a time domain resource allocation entry to the first device 110. For example, the indication may be transmitted via downlink control information. In some other example embodiments, the indication may be transmitted via a medium access control (MAC) control element (CE).

The first device 110 determines 2050 a DMRS pattern from the plurality of DMRS patterns based at least partly on the configuration. In some example embodiments, the first device 110 may determine the TDRA entry based on the indication. In this case, the TDRA entry may indicate a DMRS pattern and the first device 110 may determine the DMRS pattern based on the TDRA entry. Only as an example, if the TDRA entry indicates 12 DMRS ports for DMRS type 2, the first device 110 may determine the DMRS pattern to be 12 DMRS ports for DMRS type 2.

Alternatively, the first device 110 may determine a search space on which a physical downlink control channel (PDCCH) is detected. In this case, the first device 110 may determine the TDRA pattern based on the search space and the first mapping. Only as an example, the first mapping may indicate that Type-0 PDCCH CSS is associated with 8 DMRS ports for DMRS type 1 and Type0A-PDCCH CSS is associated with 12 DMRS ports for DMRS type 2. In this case, if the first device 110 detects the channel in Type-0 PDCCH CSS, the first device 110 may determine the DMRS pattern to be 8 DMRS ports for DMRS type 1.

In some other example embodiments, the first device 110 may determine search space on which the PDCCH is detected and determine a TDRA entry based on the search space. In this case, the first device 110 may determine the DMRS pattern indicated in the TDRA entry. For example, the PDCCH scheduled in the search space may be associated with one or more TDRA entries configured with DMRS patterns.

In some example embodiments, the first device 110 may determine a DCI format associated with the channel. In this case, the first device 110 may determine the DMRS pattern based on the DCI format and the second mapping. Only as an example, the second mapping may indicate that DCI_format 0 is associated with 8 DMRS ports for DMRS type 1 and DCI_FORMAT 1 is associated with 12 DMRS ports for DMRS type 2. In this case, if the first device 110 detects the DCI_format 0, the first device 110 may determine the DMRS pattern to be 8 DMRS ports for DMRS type 1.

In some example embodiments, the first device 110 may perform DL PDSCH reception based on the DMRS pattern. Alternatively, or in addition, the first device 110 may perform UL PUSCH transmission based on the DMRS pattern.

According to example embodiments of the present disclosure, both normal DMRS and enhanced DMRS can be supported for the terminal device according to scheduling condition. In this way, DMRS patterns can be indicated and switched dynamically, thereby improving communication performances.

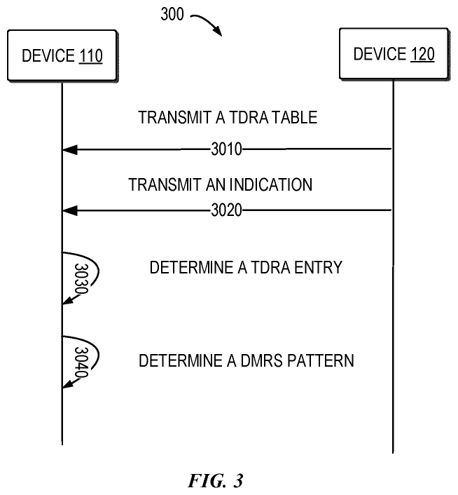

Some example embodiments of the present disclosure are described in detail below with reference to FIG. 3-FIG. 6.

FIG. 3 shows a signaling chart 300 for communication according to some example embodiments of the present disclosure. As shown in FIG. 3, the signaling chart 300 involves a first device 110 and a second device 120.

The second device 120 may transmit 3010 a TDRA table including TDRA entries to the first device 110. In some example embodiments, the TDRA table may be configured for DL. Alternatively, or in addition, the TDRA table may be configured for UL. For example, for scheduling PDSCH or PUSCH, the first device 110 may be configured with TDRA table. In some example embodiments, each TDRA entry in the TDRA table may indicate an offset k0, a mapping type and a start symbol and length (SLIV).

In some example embodiments, to support different DMRS patterns, the first device 110 may be configured with PDSCH/PUSCH-TDRA table with additional parameter of DMRS patterns. The first device 110 may be configured with TDRA entries with or without DMRS type information. When multiple DMRS patterns are supported DM-RStype-r18 can have multiple choices. Table 1 blow shows an example of TDRA entry according to some example embodiments of the present disclosure. It is noted that Table 1 is only an example not limitation.

TABLE 1

| PDSCH-TimeDomainResourceAllocation ::= | SEQUENCE { | |
|---|---|---|
| k0 | INTEGER(0..32) | OPTIONAL, -- Need S |
| mappingType | ENUMERATED {typeA, typeB}, | |
| startSymbolAndLength | INTEGER (0..127) | |
| DM-RStype-r18 | ENUMERATED {enabled} | OPTIONAL, -- Need S |

}

In some example embodiments, it may define Rel-18 DM-RS pattern associated with two DM-RS types (type 1 or type 2). Alternatively, it may define new Rel-18 DM-RS independent from normal DM-RS types. In some example embodiments, the maximum number of enhanced DMRS ports may be doubled ports: for DMRS type 1, the maximum number of enhanced DMRS ports for PDSCH/PUSCH may be single symbol DMRS with 8 DMRS ports and double symbol DMRS with 16 DMRS ports; for DMRS type 2, the maximum number of enhanced DMRS ports for PDSCH/PUSCH may be single symbol DMRS with 12 DMRS ports and double symbol DMRS with 24 DMRS ports.

Alternatively, DMRS types associated with mapping types (Type A or Type B) may be kept in the TDRA entry. Table 2 blow shows an example of TDRA entry according to some example embodiments of the present disclosure. It is noted that Table 2 is only an example not limitation.

TABLE 2

| PDSCH-TimeDomainResourceAllocation ::= | SEQUENCE { | |
|---|---|---|
| k0 | INTEGER(0..32) | OPTIONAL, -- Need S |
| mappingType | ENUMERATED {typeA, typeB}, | |
| startSymbolAndLength | INTEGER (0..127) | |
| DM-RStype-r18 | ENUMERATED {enabled} | OPTIONAL, - |

- Need S
}

In some other example embodiments, if independent mapping of DM-RS patterns are used regardless of mapping types, it may configure DM-RStype-r18 to select one option. (where type 3 or type 4 are new DMRS patterns). Table 3 blow shows an example of TDRA entry according to some example embodiments of the present disclosure. It is noted that Table 3 is only an example not limitation.

TABLE 3

| PDSCH-TimeDomainResourceAllocation ::= | SEQUENCE { | |
|---|---|---|
| k0 | INTEGER(0..32) | OPTIONAL, -- Need S |

| | |
|---|---|
| mappingType | ENUMERATED {typeA, typeB}, |
| startSymbolAndLength | INTEGER (0..127) |
| DM-RStype-r18 | ENUMERATED {type3, type4} |

OPTIONAL, -- Need S
}

The second device 120 may transmit 3020 an indication indicating a time domain resource allocation entry to the first device 110. In some example embodiments, the indication may be transmitted via downlink control information. For example, the second device 120 may be scheduled with one of TDRA entries in the TDRA table via DCI. In some other example embodiments, the indication may be transmitted via a medium access control (MAC) control element (CE).

The first device 110 may determine 3030 a TDRA entry based on the DCI. Only as an example, if the TDRA table includes 8 TDRA entries, the DCI may include a 3-bit indication which indicates the TDRA entry.

The first device 110 may determine 3040 a DMRS pattern based on the TDRA entry. For example, the first device 110 may determine the DMRS pattern indicated in the TDRA entry.

According to example embodiments described with reference to FIG. 3, it is simple and easy to support both normal DMRS and enhanced DMRS for the terminal device according to scheduling condition. In this way, DMRS patterns can be indicated and switched dynamically, thereby improving communication performances.

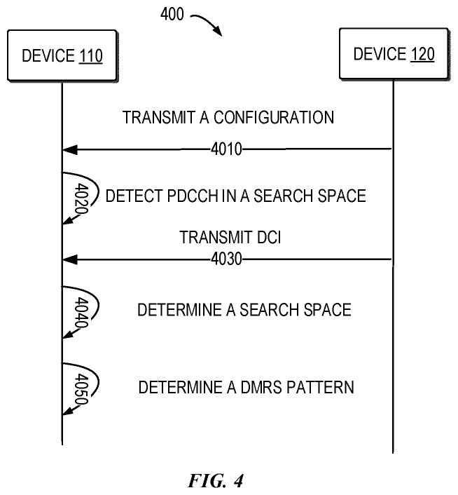

FIG. 4 shows a signaling chart 400 for communication according to some example embodiments of the present disclosure. As shown in FIG. 4, the signaling chart 400 involves a first device 110 and a second device 120.

The second device 120 may transmit 4010 a configuration including a first mapping between the plurality of DMRS patterns and a set of search spaces to the first device 110. In some example embodiments, the configuration may be a search space configuration. For example, the first mapping may indicate that a first search space is associated with a first DMRS pattern and a second search space is associated with a second DMRS pattern. In other words, the first mapping may indicate a certain search space is associated with a certain DMRS pattern.

The first device 110 may detect 4020 PDCCH in one or more search spaces. In some example embodiments, the set of search spaces may comprise a common search space (CSS). Alternatively, the set of search spaces may include a UE specific search space. In some example embodiments, the first mapping may be configured for DL. Alternatively, or in addition, the first mapping may be configured for UL. In some other example embodiments, the first mapping may be configured for DL and UL.

The second device 120 may transmit 4030 the DCI on a PDCCH to the first device 110. The first device 110 may determine 4040 a search space on which the PDCCH is detected. In this case, the first device 110 may determine 4050 a DMRS pattern based on the search space. For example, assuming that for normal, DM-RS, 4 TDRA entries are used, two search space may be supported, and for PDCCH in the normal search space, 4 TDRA entries may be used, and 2-bit DCI indication may be used.

According to example embodiments described with reference to FIG. 4, if the DMRS pattern is associated with PDSCH scheduled by PDCCH in a search space, the first device may have an assumption of the DMRS when detecting the PDCCH. In this way, it does not increase number of bits in the DCI and reduce delay caused by decoding the DCI. Moreover, the related processing may be prepared even before DCI detection.

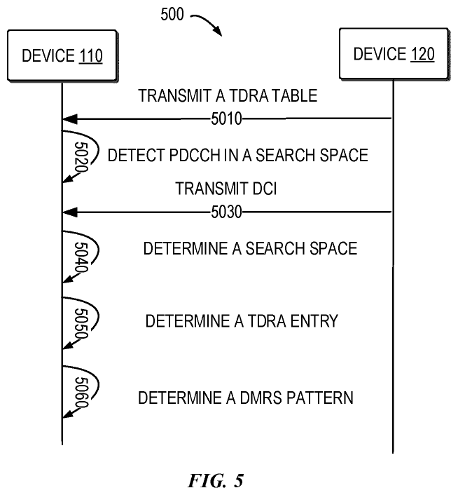

FIG. 5 shows a signaling chart 500 for communication according to some example embodiments of the present disclosure. As shown in FIG. 5, the signaling chart 500 involves a first device 110 and a second device 120.

The second device 120 may transmit 5010 a TDRA table including TDRA entries to the first device 110. In some example embodiments, the TDRA table may be configured for DL. Alternatively, or in addition, the TDRA table may be configured for UL. For example, for scheduling PDSCH or PUSCH, the first device 110 may be configured with TDRA table. In some example embodiments, each TDRA entry in the TDRA table may indicate an offset k0, a mapping type and a start symbol and length (SLIV).

In some example embodiments, to support different DMRS patterns, the first device 110 may be configured with PDSCH/PUSCH-TDRA table with additional parameter of DMRS patterns. The first device 110 may be configured with TDRA entries with or without DMRS type information.

The first device 110 may detect 5020 PDCCH in one or more search spaces. In some example embodiments, the set of search spaces may comprise a common search space (CSS). Alternatively, the set of search spaces may include a UE specific search space. In some example embodiments, the first mapping may be configured for DL. Alternatively, or in addition, the first mapping may be configured for UL. In some other example embodiments, the first mapping may be configured for DL and UL.

The second device 120 may transmit 5030 the DCI on a PDCCH to the first device 110. The first device 110 may determine 5040 a search space in which the PDCCH is detected. The first device 110 may determine 5050 a TDRA entry based on the search space. In other words, if the first device 110 is configured with an enhanced DMRS, the PDCCH scheduled in the search space may have new TDRA table where one or more TDRA entries are configured with enhanced DMRS. In this case, the first device 110 may determine 5060 the DMRS pattern based on the TDRA entry. For example, the PDCCH scheduled in the search space may be associated with one or more TDRA entries configured with DMRS patterns. For example, assuming that for normal, DM-RS, 4 TDRA entries are used, two search space may be supported, the normal search space may use 2 bit for DCI indication, and 2-3 bits may be used for search space configured with enhanced DMRS.

According to example embodiments described with reference to FIG. 5, it can reduce the required number of search space to schedule different DMRS patterns. Moreover, the number of TDRA entries can be optimized without increasing DCI indication bits.

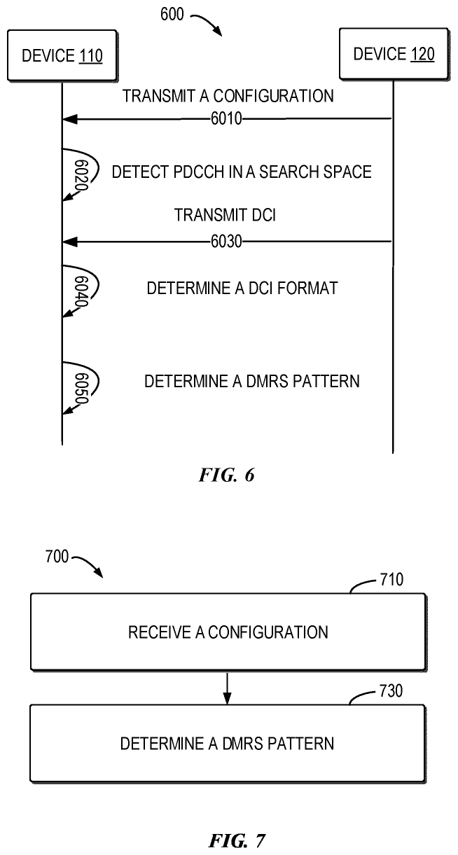

FIG. 6 shows a signaling chart 600 for communication according to some example embodiments of the present disclosure. As shown in FIG. 6, the signaling chart 600 involves a first device 110 and a second device 120.

The second device 120 may transmit 6010 a configuration indicating a second mapping between the plurality of DMRS patterns and a set of DCI formats. For example, the second mapping may indicate that a first search space is associated with a first DMRS pattern and a second search space is associated with a second DMRS pattern. In other words, the second mapping may indicate a certain DCI format is associated with a certain DMRS.

The first device 110 may detect 6020 PDCCH in one or more search spaces. In some example embodiments, the set of search spaces may comprise a common search space (CSS). Alternatively, the set of search spaces may include a UE specific search space.

The second device 120 may transmit 6030 the DCI on a PDCCH to the first device 110. The first device 110 may determine 6040 a DCI format based on the DCI. In this case, the first device 110 may determine 6050 a DMRS pattern based on the DCI format and the second mapping.

Only as an example, the second mapping may indicate that DCI format 0 is associated with 8 DMRS ports for DMRS type 1 and DCI_FORMAT 1 is associated with 12 DMRS ports for DMRS type 2. In this case, if the first device 110 detects the DCI_format 0, the first device 110 may determine the DMRS pattern to be 8 DMRS ports for DMRS type 1.

According to example embodiments described with reference to FIG. 6, it does not increase number of bits in the DCI and reduce delay caused by decoding the DCI. Moreover, the related processing may be prepared even before DCI detection.

### Example Methods

FIG. 7 shows a flowchart of an example method 700 implemented at a first device in accordance with some example embodiments of the present disclosure. For the purpose of discussion, the method 700 will be described from the perspective of the first device 110 in FIG. 1.

At block 710, the first device receives a configuration associated with a plurality of demodulation reference signal patterns from a second device. In some example embodiments, the configuration may include a time domain resource allocation table that comprises a plurality of time domain resource allocation entries. In some example embodiments, at least one time domain resource allocation entry in the time domain resource allocation table may include an indication of demodulation reference signal pattern. In some example embodiments, the time domain resource allocation table may be configured for downlink reception or uplink transmission.

Alternatively, the configuration may indicate a first mapping between the plurality of demodulation reference signal patterns and a set of search spaces. In some example embodiments, the configuration may indicate a second mapping between the plurality of demodulation reference signal patterns and a set of downlink control information formats.

In some example embodiments, the first device may receive an indication indicating a TDRA entry from the second device. For example, the indication may be transmitted via downlink control information. In some other example embodiments, the indication may be transmitted via a medium access control (MAC) control element (CE).

At block 730, the first device determines a demodulation reference signal pattern to be used from the plurality of demodulation reference signal patterns based at least partly on the configuration. In some example embodiments, the first device may determine the time domain resource allocation entry based on the downlink control information. In this case, the first device may determine a demodulation reference signal pattern indicated in the time domain resource allocation entry as the demodulation reference signal pattern.

In some example embodiments, the first device may determine a search space on which the PDCCH is detected. In this case, the first device may determine the demodulation reference signal pattern based on the search space and the first mapping. In some example embodiments, the first mapping may be configured for one at least one of: a downlink reception or an uplink transmission.

Alternatively, the first device may determine a search space on which the PDCCH is detected. The first device may also determine a time domain resource allocation entry based on the search space. In this case, the first device may determine a demodulation reference signal pattern indicated in the time domain resource allocation entry.

In some other example embodiments, the first device may determine a downlink control information format associated with the channel. In this case, the first device may determine the demodulation reference signal pattern based on the downlink control information format and the second mapping.

In some example embodiments, the first device may perform at least one of: a transmission or a reception with the second device based on the demodulation reference signal pattern.

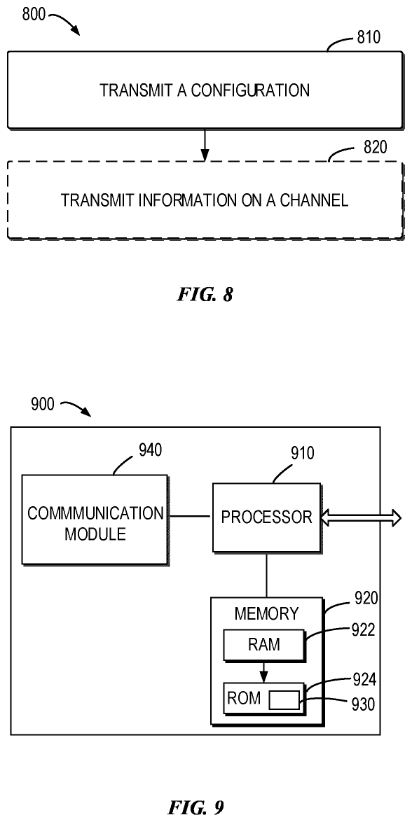

FIG. 8 shows a flowchart of an example method 800 implemented at a second device in accordance with some example embodiments of the present disclosure. For the purpose of discussion, the method 800 will be described from the perspective of the second device 120 in FIG. 1.

At block 810, the second device transmits configuration associated with a plurality of demodulation reference signal patterns to a first device. In some example embodiments, the configuration may include a time domain resource allocation table that comprises a plurality of time domain resource allocation entries. In some example embodiments, at least one time domain resource allocation entry in the time domain resource allocation table may include an indication of demodulation reference signal pattern. In some example embodiments, the time domain resource allocation table may be configured for downlink reception or uplink transmission.

Alternatively, the configuration may indicate first mapping between the plurality of demodulation reference signal patterns and a set of search spaces. In some example embodiments, the configuration may indicate second mapping between the plurality of demodulation reference signal patterns and a set of downlink control information formats.

In some example embodiments, at block 820, the second device may transmit to the first device information on a channel between the first and second devices. The information is used for determining a demodulation reference signal pattern from the plurality of demodulation reference signal patterns. For example, the second device may transmit an indication indicating a TDRA entry to the first device. In some example embodiments, the indication may be transmitted via downlink control information. In some other example embodiments, the indication may be transmitted via a medium access control (MAC) control element (CE).

### Example Apparatus, Device and Medium

In some example embodiments, a first apparatus capable of performing any of the method 700 (for example, the first device 110 in FIG. 1) may comprise means for performing the respective operations of the method 700. The means may be implemented in any suitable form. For example, the means may be implemented in a circuitry or software module. The first apparatus may be implemented as or included in the first device 110 in FIG. 1.

In some example embodiments, the first apparatus comprises means for receiving, from a network device, a configuration associated with a plurality of demodulation reference signal patterns; and means for determining, based at least partly on the configuration, a demodulation reference signal pattern to be used from the plurality of demodulation reference signal patterns.

In some example embodiments, the means for receiving the configuration comprises means for receiving, from the network device, a time domain resource allocation table comprising a plurality of time domain resource allocation entries, wherein at least one time domain resource allocation entry in the time domain resource allocation table comprises information related to a demodulation reference signal pattern of the plurality of demodulation reference signal patterns.

In some example embodiments, the first apparatus comprises means for receiving, from the network device, an indication indicating a time domain resource allocation entry via downlink control information or a medium access control control element.

In some example embodiments, the means for determining the demodulation reference signal pattern comprises: means for determining, based at least partly on the indicated time domain resource allocation entry, a demodulation reference signal pattern to be used.

In some example embodiments, the time domain resource allocation table is for at least one of: a downlink reception or an uplink transmission.

In some example embodiments, the means for receiving the configuration comprises: means for receiving, from the network device, the configuration indicating a first mapping between the plurality of demodulation reference signal patterns and a set of search spaces.

In some example embodiments, the means for determining the demodulation reference signal pattern comprises: means for determining a search space on which a physical downlink control channel is detected; and means for determining the demodulation reference signal pattern based on the search space and the first mapping.

In some example embodiments, the first mapping is for at least one of: a downlink reception or an uplink transmission.

In some example embodiments, the means for determining the demodulation reference signal pattern comprises: means for determining a search space on which a physical downlink control channel is detected; means for determining a time domain resource allocation entry based on the search space; and means for determining the demodulation reference signal pattern based on the time domain resource allocation entry.

In some example embodiments, the means for receiving from the second device the configuration comprises means for receiving, from the network device, the configuration indicating a second mapping between the plurality of demodulation reference signal patterns and a set of downlink control information formats.

In some example embodiments, the means for determining the demodulation reference signal pattern comprises: means for determining a downlink control information format; and means for determining the demodulation reference signal pattern based on the downlink control information format and the second mapping.

In some example embodiments, the first apparatus comprises means for performing at least one of: a transmission or a reception with the second device based on the target demodulation reference signal pattern.

In some example embodiments, the first device comprises a terminal device.

In some example embodiments, a second apparatus capable of performing any of the method 800 (for example, the second device 120 in FIG. 1) may comprise means for performing the respective operations of the method 800. The means may be implemented in any suitable form. For example, the means may be implemented in a circuitry or software module. The second apparatus may be implemented as or included in the second device 120 in FIG. 1.

In some example embodiments, the second apparatus comprises means for transmitting, to a terminal device, a configuration associated with a plurality of demodulation reference signal patterns, the configuration being used for determining a demodulation reference signal pattern to be used from the plurality of demodulation reference signal patterns.

In some example embodiments, the means for transmitting the configuration comprises: means for transmitting, to the terminal device, a time domain resource allocation table comprising a plurality of time domain resource allocation entries, wherein at least one time domain resource allocation entry in the time domain resource allocation table comprises information related to a demodulation reference signal pattern of the plurality of demodulation reference signal patterns.

In some example embodiments, the second apparatus comprises means for transmitting, to the terminal device, a time domain resource allocation entry via downlink control information or a medium access control control element.

In some example embodiments, the time domain resource allocation table is for at least one of: a downlink reception or an uplink transmission.

In some example embodiments, the means for transmitting the configuration comprises: means for transmitting, to the terminal device, the configuration indicating a first mapping between the plurality of demodulation reference signal patterns and a set of search spaces.

In some example embodiments, the first mapping is for at least one of: a downlink reception or an uplink transmission.

In some example embodiments, the means for transmitting the configuration comprises: means for transmitting, to the terminal device, the configuration indicating a second mapping between the plurality of demodulation reference signal patterns and a set of downlink control information formats.

In some example embodiments, the apparatus comprises a network device.

FIG. 9 is a simplified block diagram of a device 900 that is suitable for implementing example embodiments of the present disclosure. The device 900 may be provided to implement a communication device, for example, the first device 110 or the second device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIG. 2 to FIG. 8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

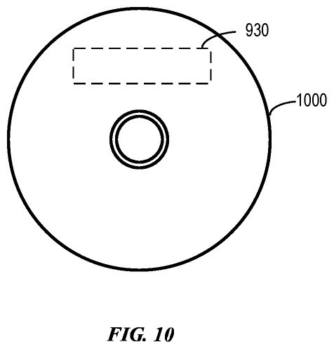

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. An apparatus comprising:
at least one processor; and
at least one memory storing instructions that, when executed by the at least one processor, cause the apparatus at least to perform:
receiving, from a network device, a configuration associated with a plurality of demodulation reference signal patterns; and
determining, based at least partly on the configuration, a demodulation reference signal pattern to be used from the plurality of demodulation reference signal patterns.

27. The apparatus according to claim 26, wherein receiving the configuration comprises:
receiving, from the network device, a time domain resource allocation table comprising a plurality of time domain resource allocation entries, wherein at least one time domain resource allocation entry in the time domain resource allocation table comprises information related to a demodulation reference signal pattern of the plurality of demodulation reference signal patterns.

28. The apparatus according to claim 26, wherein the apparatus is further caused to perform:
receiving, from the network device, an indication indicating a time domain resource allocation entry via downlink control information or a medium access control control element.

29. The apparatus according to claim 26, wherein determining the demodulation reference signal pattern comprises:
determining, based at least partly on the indicated time domain resource allocation entry, a demodulation reference signal pattern to be used.

30. The apparatus according to claim 26, wherein the time domain resource allocation table is for at least one of: a downlink reception or an uplink transmission.

31. The apparatus according to claim 26, wherein receiving the configuration comprises:
receiving, from the network device, the configuration indicating a mapping between the plurality of demodulation reference signal patterns and a set of search spaces.

32. The apparatus according to claim 31, wherein determining the demodulation reference signal pattern comprises:
determining a search space on which a physical downlink control channel is detected; and
determining the demodulation reference signal pattern based on the search space and the mapping.

33. The apparatus according to claim 32, wherein the mapping is for at least one of: a downlink reception or an uplink transmission.

34. The apparatus according to claim 26, wherein determining the demodulation reference signal pattern comprises:
determining a search space on which a physical downlink control channel is detected;
determining a time domain resource allocation entry based on the search space; and
determining the demodulation reference signal pattern based on the time domain resource allocation entry.

35. The apparatus according to claim 26, wherein receiving the configuration comprises:
receiving, from the network device, the configuration indicating a mapping between the plurality of demodulation reference signal patterns and a set of downlink control information formats.

36. The apparatus according to claim 35, wherein determining the demodulation reference signal pattern comprises:
determining a downlink control information format; and
determining the demodulation reference signal pattern based on the downlink control information format and the mapping.

37. The apparatus according to claim 26, wherein the apparatus is also caused to perform:
performing at least one of: a transmission or a reception with the network device, based on the demodulation reference signal pattern.

38. An apparatus comprising:
at least one processor; and
at least one memory storing instructions that, when executed by the at least one processor, cause the apparatus at least to perform:
transmitting, to a terminal device, a configuration associated with a plurality of demodulation reference signal patterns, the configuration being used for determining a demodulation reference signal pattern to be used from the plurality of demodulation reference signal patterns.

39. The apparatus according to claim 38, wherein transmitting the configuration comprises:
transmitting, to the terminal device, a time domain resource allocation table comprising a plurality of time domain resource allocation entries, wherein at least one time domain resource allocation entry in the time domain resource allocation table comprises information related to a demodulation reference signal pattern of the plurality of demodulation reference signal patterns.

40. The apparatus according to claim 38, wherein the apparatus is further caused to perform:
transmitting, to the terminal device, a time domain resource allocation entry via downlink control information or a medium access control control element.

41. The apparatus according to claim 40, wherein the time domain resource allocation table is for at least one of: a downlink reception or an uplink transmission.

42. The apparatus according to claim 37, wherein transmitting the configuration comprises:
transmitting, to the terminal device, the configuration indicating a mapping between the plurality of demodulation reference signal patterns and a set of search spaces.

43. The apparatus according to claim 42, wherein the mapping is for at least one of: a downlink reception or an uplink transmission.

44. The apparatus according to claim 38, wherein transmitting the configuration comprises:
transmitting, to the terminal device, the configuration indicating a mapping between the plurality of demodulation reference signal patterns and a set of downlink control information formats.

45. A method comprising:
receiving, at a terminal device and from a network device, a configuration associated with a plurality of demodulation reference signal patterns; and
determining, based at least partly on the configuration, a demodulation reference signal pattern to be used from the plurality of demodulation reference signal patterns.
